(19) United States
(12) Patent Application Publication
(10) Pub. No.: US 2022/0124603 A1
(43) Pub. Date: Apr. 21, 2022

(54) METHOD FOR SLICE-BASED ACCESS BARRING AND USER EQUIPMENT USING THE SAME

(71) Applicant: Industrial Technology Research Institute, Hsinchu (TW)

(72) Inventors: Tzu-Jane Tsai, Hsinchu County (TW); Chun-Yuan Chiu, Pingtung County (TW)

(73) Assignee: Industrial Technology Research Institute, Hsinchu (TW)

(21) Appl. No.: 17/472,690

(22) Filed: Sep. 12, 2021

Related U.S. Application Data
(60) Provisional application No. 63/093,311, filed on Oct. 19, 2020.

(51) Int. Cl. H04W 48/10; H04W 48/02

(52) U.S. Cl. CPC H04W 48/10; H04W 48/02

(57) ABSTRACT

A method for slice-based access barring and a user equipment are provided. The method includes: acquiring, by the non-access stratum, a unicasted non-access stratum signalling, wherein the unicasted non-access stratum signalling comprises an access category definition corresponding to a network slice; acquiring, by the access stratum, broadcasted system information, wherein the broadcasted system information comprises a local access category definition corresponding to the network slice; delivering, by the access stratum, the local access category definition to the non-access stratum; initiating, by the non-access stratum, an access attempt; determining, by the non-access stratum, an access category of the access attempt according to the access category definition and the local access category definition; and performing, by the access stratum, an access barring check for the access attempt according to the access category.

### CROSS-REFERENCE TO RELATED APPLICATION

This application claims the priority benefit of U.S. provisional application Ser. No. 63/093,311, filed on Oct. 19, 2020. The entirety of the above-mentioned patent application is hereby incorporated by reference herein and made a part of this specification.

### BACKGROUND

### Technical Field

The disclosure provides a method for slice-based access barring and user equipment (UE) using the same.

### Description of Related Art

Network slicing is one of key features of 5G communication. 3GPP specification TR 38.832 provides mechanisms to enable a UE fast access to a network slice supported by a cell. The mechanisms include, for example, slice-based cell reselection under network control, slice-based random access channel (RACH) configuration, or slice-based access barring. Thus, how to bring enhancement to those mechanisms is important to the communication technique field.

### SUMMARY

The disclosure provides a method for slice-based access barring and a UE using the same. The method may assist the UE to perform the slice-based access barring in a more efficient way.

A method for slice-based access barring adapted to a user equipment comprising an access stratum and a non-access stratum is provided. The method comprising: acquiring, by the non-access stratum, a unicasted non-access stratum signalling, wherein the unicasted non-access stratum signalling comprises an access category definition corresponding to a network slice; acquiring, by the access stratum, broadcasted system information, wherein the broadcasted system information comprises a local access category definition corresponding to the network slice; delivering, by the access stratum, the local access category definition to the non-access stratum; initiating, by the non-access stratum, an access attempt; determining, by the non-access stratum, an access category of the access attempt according to the access category definition and the local access category definition; and performing, by the access stratum, an access barring check for the access attempt according to the access category.

In an embodiment of the disclosure, the method further comprising: acquiring, by the access stratum, second broadcasted system information after acquiring the broadcasted system information, wherein the second broadcasted system information comprises a second local access category definition; delivering, by the access stratum, the second local access category definition to the non-access stratum; and updating, by the non-access stratum, the local access category definition to the second local access category definition.

In an embodiment of the disclosure, the method further comprising: acquiring, by the access stratum, second broadcasted system information after acquiring the broadcasted system information, wherein the second broadcasted system information comprises no local access category definition; notifying, by the access stratum, no local access category definition in the second broadcasted system information to the non-access stratum; and discarding, by the non-access stratum, the local access category definition in response to no local access category definition in the second broadcasted system information.

In an embodiment of the disclosure, wherein the access stratum acquires the broadcasted system information from a first base station, and the access stratum acquires the second broadcasted system information from a second base station after performing a handover from the first base station to the second base station.

In an embodiment of the disclosure, the broadcasted system information further comprises barring control information corresponding to the local access category definition, wherein the access stratum performs the access barring check according to the barring control information.

In an embodiment of the disclosure, wherein the local access category definition is associated with an operator-defined access category.

A method for slice-based access barring adapted to a user equipment comprising an access stratum and a non-access stratum is provided. The method comprising: acquiring, by the non-access stratum, a unicasted non-access stratum signalling, wherein the unicasted non-access stratum signalling comprises an access category definition corresponding to a network slice; initiating, by the non-access stratum, an access attempt; determining, by the non-access stratum, an access category of the access attempt according to the access category definition and an additional access category of the access attempt; and performing, by the access stratum, an access barring check for the access attempt according to the access category.

In an embodiment of the disclosure, the method further comprising: acquiring, by the access stratum, broadcasted system information, wherein the broadcasted system information comprises a barring control information corresponding to a second additional access category; performing the access barring check according to the barring control information if the additional access category of the access attempt is equal to the second additional access category; and performing the access barring check according to a second barring control information corresponding to the access category of the access attempt if the additional access category of the access attempt is not equal to the second additional access category.

In an embodiment of the disclosure, wherein the unicasted non-access stratum signalling comprises a mapping relationship between the additional access category and the network slice.

A user equipment (UE) for slice-based access barring is provided. The UE comprising: a transceiver, a storage medium, and a processor. The storage medium comprising an access stratum and a non-access stratum. The processor coupled to the storage medium and the transceiver, wherein the processor is configured to: acquire, by the non-access stratum, a unicasted non-access stratum signalling via the transceiver, wherein the unicasted non-access stratum signalling comprises an access category definition corresponding to a network slice; acquire, by the access stratum, broadcasted system information via the transceiver, wherein the broadcasted system information comprises a local access category definition corresponding to the network slice; deliver, by the access stratum, the local access category definition to the non-access stratum; initiate, by the non-access stratum, an access attempt; determine, by the non-access stratum, an access category of the access attempt according to the access category definition and the local access category definition; and perform, by the access stratum, an access barring check for the access attempt according to the access category via the transceiver.

A user equipment (UE) for slice-based access barring is provided. The UE comprising a transceiver, a storage medium, and a processor. The storage medium comprising an access stratum and a non-access stratum. The processor coupled to the storage medium and the transceiver, wherein the processor is configured to: acquire, by the non-access stratum, a unicasted non-access stratum signalling via the transceiver, wherein the unicasted non-access stratum signalling comprises an access category definition corresponding to a network slice; initiate, by the non-access stratum, an access attempt; determine, by the non-access stratum, an access category of the access attempt according to the access category definition and an additional access category of the access attempt; and perform, by the access stratum, an access barring check for the access attempt according to the access category.

Based on the above, the disclosure may provide multiple kinds of access category definition to a UE. The UE may determine an access category of an access attempt by selecting one of the access category definition according to a reception of a signalling. Accordingly, even if the number of the signalling between the network and the UE is minimized, the network may command the UE to stop accessing a congested network slice in any time by sending a signalling to the UE.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 illustrates a signalling diagram of updating access category definitions.

FIG. 2 illustrates a signalling diagram of updating barring control information.

FIG. 3 illustrates a signalling diagram of a procedure of slice-based access barring according to an embodiment of the disclosure.

FIG. 4 illustrates a schematic diagram of determining the access category of the access attempt according to an embodiment of the disclosure.

FIG. 5 illustrates a schematic diagram of determining the access category of the access attempt according to another embodiment of the disclosure.

FIG. 6 illustrated a schematic diagram of determining the access category of the access attempt according to another embodiment of the disclosure.

FIG. 7 illustrates a schematic diagram of UE AS behavior for updating local access category definitions according to an embodiment of the disclosure.

FIG. 8 illustrates a schematic diagram of UE AS behavior for updating local access category definitions according to another embodiment of the disclosure.

FIG. 9 illustrates a signalling diagram of obtaining barring control information associated with additional access category definitions according to an embodiment of the disclosure.

FIG. 10 illustrates a signalling diagram of a procedure of slice-based access barring according to an embodiment of the disclosure.

FIG. 11 illustrates a flowchart diagram of a method for determining which barring control information shall be applied according to an embodiment of the disclosure.

FIG. 12 illustrates a schematic diagram of access category of an access attempt according to an embodiment of the disclosure.

FIG. 13 illustrates a schematic diagram of access category of an access attempt according to another embodiment of the disclosure.

FIG. 14 illustrates a flowchart diagram of a method for slice-based access barring according to an embodiment of the disclosure.

FIG. 15 illustrates a flowchart diagram of a method for slice-based access barring according to another embodiment of the disclosure.

FIG. 16 illustrates a schematic diagram of a UE according to an embodiment of the disclosure.

### DESCRIPTION OF THE EMBODIMENTS

A network slice may be uniquely identified by a single network slice selection assistance information (S-NSSAI). A S-NSSAI may include a mandatory slice/service type (SST) field which identifies the type of a network slice by 8 bits data. The S-NSSAI may further include an optional slice differentiator (SD) field which consists of 24 bits data. In some cases, the SST fields of different network slices may be the same, and the SD fields of different network slices may be differentiated. For example, a network operator may deploy multiple network slices delivering the same features for different groups of UE by configuring the multiple network slices with the same SST field but different SD fields.

The network may perform access control for a UE intending to access a network slice, so as to limit the access attempts from the UE by using unified access control (UAC) functionality as specified in 3GPP specification TS 22.261, TS 24.501, or TS 38.300. The network operator may define multiple operator-defined access categories which can be used to enable differentiated handling for different network slices. The network may broadcast barring control information (i.e., a list of barring parameters associated with operator-defined access categories) so as to minimize the impact of the congested network slices.

Under high network load condition, the network may protect itself from overload by performing unified access control according to the unified access control functionality. The network may initiate such unified access control when, for example, the access and mobility management (AMF) function request to restrict the load for UE that accesses the network by sending an OVERLOAD START message containing conditions defined in clause 5.19.5.2 of 3GPP specification TS 23.501. For another example, the network may initiate the unified access control if the operations, administration, and maintenance (OAM) function requests. For the other example, the network may trigger itself to initiate the unified access control.

Unified access control framework may apply to all UE state defined in 5G new radio (NR) such as “RRC IDLE” state, “RRC INACTIVE” state, or “RRC CONNECTED” state. The network may broadcast barring control information associated with one or more access categories. When an access attempt is generated by an application layer of a UE, the UE may determine whether the access category of the access attempt matched with operator-defined access categories (or standardized access categories). Specifically, the UE may store a mapping table for access categories. Table 1 is an example of the mapping table which is similar the table 4.5.2.2 of 3GPP specification TS 24.501. If the access attempt is matched with a rule in the mapping table, the UE may determine the access category of the access attempt according to the rule. On the other hand, if the access attempt is matched with multiple rules in the mapping table, the UE may determine the access category of the access attempt according to the lowest rule number among the multiple rules.

TABLE 1

| Rule # | Type of access attempt | Requirements to be met | Access Category |
|---|---|---|---|
| 1 | Response to paging . . . | Access attempt is for MT access, . . . | 0 (=MT_acc) |
| 2 | Emergency | UE is attempting access for an | 2 (=emergency) |
| | | emergency session | |
| 3 | Access attempt for | UE stores operator-defined access | 32-63 |
| | operator-defined access | category definitions valid in the | |
| | category | current PLMN as specified in | |
| | | subclause 4.5.3, and access attempt is | |
| | | matching criteria of an operator- | |
| | | defined access category definition | |
| 3.1 | Access attempt for MO | omit . . . | 10 (=MO |
| | exception data | | exception data) |
| 4 | Access attempt for | omit . . . | 1 (=delay |
| | delay tolerant service | | tolerant) |
| 4.1 | MO IMS registration | omit . . . | 9 (=MO IMS |
| | related signalling | | registration |
| | | | related |
| | | | signalling) |
| 5 | MO MMTel voice call | omit . . . | 4 (=MO MMTel |
| | | | voice) (includes |
| | | | Real-Time Text) |
| 6 | MO MMTel video call | omit . . . | 5 (=MO MMTel |
| | | | video) |
| 7 | MO SMS over NAS or | omit . . . | 6 (=MO SMS |
| | MO SMSoIP | | and SMSoIP) |
| 8 | UE NAS initiated | Access attempt is for MO signalling | 3 (=MO_sig) |
| | 5GMN specific | | |
| | procedures | | |
| . . . | . . . | . . . | . . . |
| 10 | An uplink user data | No further requirement is to be met | 7 (=MO_data) |
| | packet is to be sent for | | |
| | a PDU session with | | |
| | suspended user-plane | | |
| | resources | | |

If the access attempt meets the requirements of multiple operator-defined access category definitions, the UE may determine the access attempt according to an operator-defined access category definition with the lowest precedence value. An operator-defined access category definition may consist of parameters such as a precedence value, an operator-defined access category number, criteria consisting of one or more access category criteria type and associated access category criteria type values, or a standardized access category. Each operator-defined access category definition may have a different precedence value. Different operator-defined access category definitions may have the same operator-defined access category number. The access category criteria type may include data network name (DNN), 5G quality of service identifier (5QI), operating system identifier (OSId) triggering the access attempt, operating system specific application identifier (OSAppId) triggering the access attempt, or S-NSSAI. The standardized access category may be used in combination with the access identities of the UE to determine the radio resource control (RRC) establishment cause.

One or more operator-defined access category definitions may be signaled to the UE via a unicasted non-access stratum (NAS) signalling. The NAS signalling may be received by a NAS of the UE, wherein the NAS signalling may be “REGISTRATION ACCEPT message”. The UE may obtain the one or more operator-defined access category definitions from an operator-defined access category definitions information element (IE) included in the NAS signalling. After the NAS signalling is received by the UE, the UE may feedback a response message to the AMF so as to acknowledge the reception of the one or more operator-defined access category definitions, wherein the response message may be “REGISTRATION COMPLETE message”. In one embodiment, the NAS signalling (or the access category definition) may include mapping relationships between network slices and access categories.

On the other hand, if the UE obtains the operator-defined access category definitions information element from “CONFIGURATION UPDATE COMMAND message” received by the UE, and the operator-defined access category definitions information includes one or more operator-defined access category definitions, the UE shall replace any operator-defined access category definitions stored for the registered public land mobile network (RPLMN) by the received operator-defined access category definitions. It should be noted that the maximum number of operator-defined access category definitions stored in the UE is UE implementation dependent.

After the access category of the access attempt is determined, the UE may perform an access barring check for the network slice according to the access category and unified access control barring parameters (i.e., barring control information) corresponding to the access category, wherein the unified access control barring parameters may include “uac-barringInfoSetIndex”, “uac-BarringFactor”, “uac-BarringTime”, or “uac-BarringForAccessIdentity”. Parameter “uac-BarringFactor” may represent the probability that an access attempt would be allowed during the access barring check. Parameter “uac-BarringTime” may represent a minimum time in seconds before a new access attempt is to be performed after an access attempt was barred at the access barring check, wherein the access attempt and the new access attempt correspond to the same access category. Parameter “uac-BarringForAccessIdentity” may indicate whether an access attempt corresponding to a specific access identity is allowed. Table 2 is an example of parameter “uac-BarringForAccessIdentity”. For example, if “bit 0” of the bitmap received by the UE is equal to “0”, the UE may determine that an access attempt corresponding to the “access identity 1” is allowed. If “bit 1” of the bitmap received by the UE is equal to “0”, the UE may determine that an access attempt corresponding to the “access identity 2” is allowed.

TABLE 2

| bitmap | 0 | 1 | 2 | 3 | 4 | 5 | 6 |
|---|---|---|---|---|---|---|---|
| Access | 1 | 2 | 11 | 12 | 13 | 14 | 15 |
| Identity | | | | | | | |

At least one mapping relationship among an access category and unified access control barring parameters may be signaled to the UE via an access stratum (AS) signalling (e.g., RRC signalling), such as a system information block (SIB). Table 3 is an example of the mapping relationship. The UE may perform an access barring check according to the access category and the unified access control parameters, as shown in the code in Table 4 (refer to 3GPP specification TS38.331, clause 5.3.14.5).

TABLE 3

| uac-BarringForCommon | | uac-BarringInfoSetList | | |
|---|---|---|---|---|
| Access | uac-barring | uac-Barring | uac-Barring | uac-Barring |
| Category | InfoSetIndex | Factor | Time | ForAccessIdentity |
| 1 | one of 1~8 | . . . | . . . | . . . |
| 2 | 3 | . . . | . . . | . . . |
| . . . | . . . | . . . | . . . | . . . |
| 63 | 1 | p00, p05, | s4, s8, | BIT STRING |
| | | . . . , p95 | . . . , s512 | (SIZE(7)) |

TABLE 4
The UE shall:

| | |
|---|---|
| 1> | if one or more Access Identities are indicated according to TS 24.501, and |
| 1> | if for at least one of these Access Identities the corresponding bit in the uac- |

BarringForAccessIdentity contained in “UAC barring parameter” is set to zero:

| | |
|---|---|
| 2> | consider the access attempt as allowed; |
| 1> | else: |
| 2> | draw a random number ‘rand’ uniformly distributed in the range: 0≤rand<1; |
| 2> | if ‘rand’ is lower than the value indicated by uac-BarringFactor included in “UAC |

barring parameter”:

| | |
|---|---|
| 3> | consider the access attempt as allowed; |
| 2> | else: |
| 3> | consider the access attempt as barred; |
| 1> | if the access attempt is considered as barred: |
| 2> | draw a random number ‘rand’ that is uniformly distributed in the range 0≤rand<1; |
| 2> | start timer T390 for the Access Category with the timer value calculated as follows, |

using the uac-BarringTime included in “UAC barring parameter”:

T390 = (0.7 + 0.6 * rand) * uac-BarringTime

MO: Mobile Originating MT: Mobile Termination

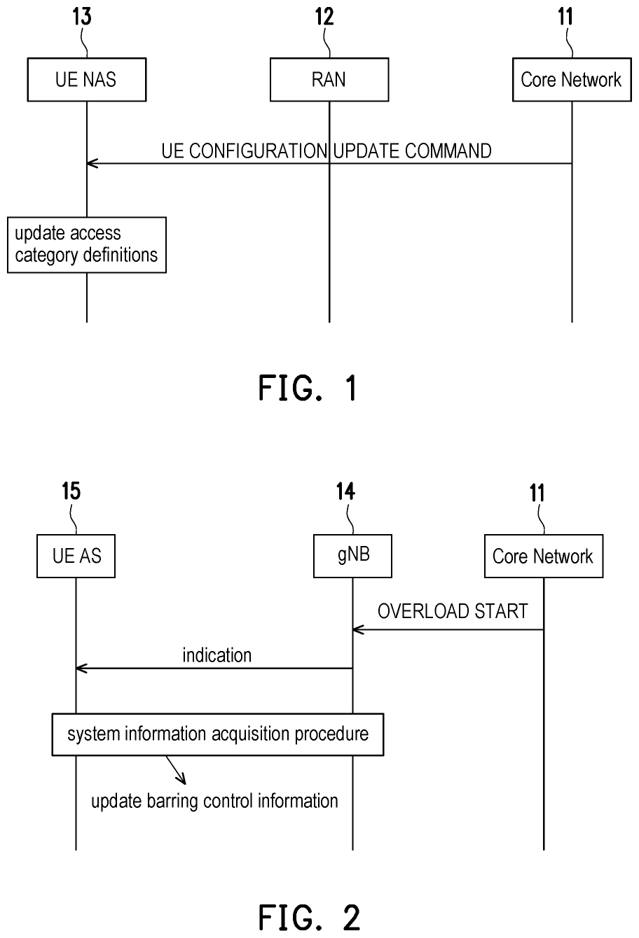

In order to perform slice-based access barring, the UE shall update the access category definitions and the barring control information dynamically. FIG. 1 illustrates a schematic diagram of updating access category definitions. The core network (or AMF) 11 may transmit a NAS signalling to the UE through a radio access network (RAN) 12, wherein the NAS signalling may be “UE CONFIGURATION UPDATE COMMAND”. The UE NAS (i.e., NAS of UE) 13 may receive the NAS signalling and may update the access category definitions according to the NAS signalling. The updating procedure in FIG. 1 can only be used when the UE has an established 5G mobility management (SGMM) context and the UE is in a SGMM-CONNECTED mode. If the UE is in SGMM-IDLE mode, the core network 11 may use the paging or notification procedure to initiate the updating procedure for the UE.

FIG. 2 illustrates a signalling diagram of updating barring control information. When a network slice congestion occurs, the core network 11 may transmit a message, such as “OVERLOAD START” message, to the gNB 14 so as to indicate a congested network slice. The gNB 14 may include a concerned cell to the core network 11. That is, the core network 11 wants to limit access attempts for the congested network slice from the gNB 14. After receiving “OVERLOAD START” message, the gNB 14 may transmit an indication associated with changing of system information to the UE via a paging message or downlink control information (DCI), wherein the indication may be carried by an AS signalling. The UE may be a concerned UE. That is, the UE may initiate an access attempt for the congested network slice. The UE AS (i.e., access stratum or RRC layer of UE) 15 may receive the indication and may perform a system information (SI) acquisition procedure with the gNB 14 according to the indication. The barring control information stored in the UE may be updated during the system information acquisition procedure. It should be noted that no matter the UE is in the state of “RRC IDLE”, “RRC INACTIVE”, or “RRC CONNECTED”, the UE needs to monitor the paging message (or the DCI) so as to determine whether the system information has changed. The UE AS 15 may include an RRC layer, a packet data convergence protocol (PDCP) layer, a radio link control (RLC) layer, a media access control (MAC) layer, or a physical (PHY) layer.

When a network slice congestion occurs, the congested network slice shall be mapped to an unused operator-defined access category or a barred operator-defined access category, and the network shall inform the UE which network slice is congested. In some cases, the network may inform the UE which network slice is congested by sending a S-NSSAI corresponding to the congested network slice to the UE via an AS signalling. However, according to Table 1, the maximum number of operator-defined access categories may equal to merely 32 (i.e., the number of access categories 32-63). Since an S-NSSAI may include 32 bits data, the maximum number of network slices defined by the S-NSSAI may equal to 2\hat{ }32, which is much larger than the maximum number of the operator-defined access categories. That is, the S-NSSAIs cannot map onto the access categories in a one-to-one manner. Therefore, the network cannot indicate to the UE all of the network slices by just using the operator-defined access categories. On the other hand, the network may configure the UE to update the operator-defined access category definitions stored in the UE more frequently. The network may indicate a specific network slice to the UE by using one of the operator-defined access category definitions stored in the UE. However, the frequently updating of the operator-defined access category definitions may increase the signalling overhead.

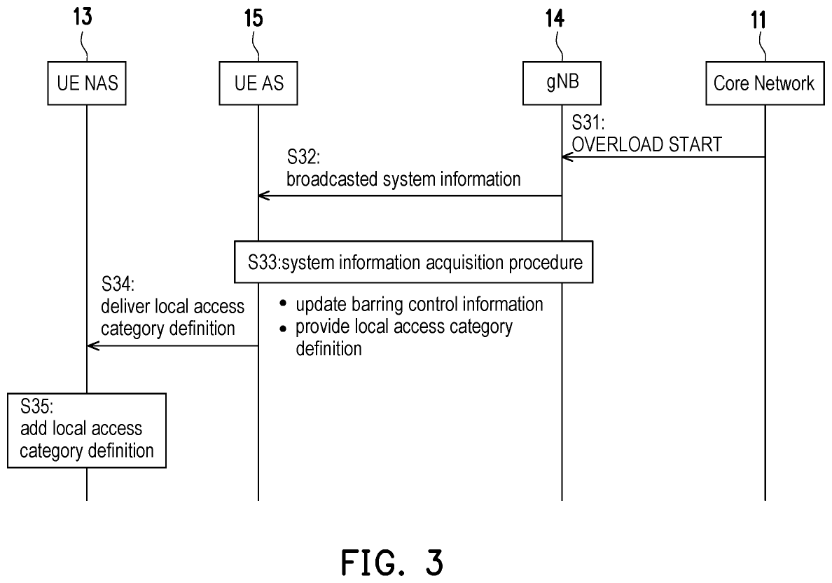

FIG. 3 illustrates a signalling diagram of a procedure of slice-based access barring according to an embodiment of the disclosure. In the embodiment, the UE may pre-store at least one stored access category definition corresponding to at least one network slice, wherein the stored access category definition may be configured by a unicasted NAS signalling. For example, the core network 11 may transmit a NAS signalling to the UE, wherein the NAS signalling may include a stored access category definition. The UE may obtain the stored access category definition by acquiring the NAS signalling via the UE NAS 13. The UE NAS 13 may store the stored access category definition.

In step S31, when a network slice congestion occurs, the core network 11 may map the congested network slice to a local access category definition, wherein the local access category definition may correspond to an operator-defined access category such as an unused operator-defined access category or a barred operator-defined access category. The core network 11 may transmit a message, such as “OVERLOAD START” message, to the gNB 14 so as to indicate the congested network slice, wherein the message may include the at least one local access category definition. The gNB 14 may include several concerned cells to the core network 11. That is, the core network 11 wants to prevent the concerned cells belonged to gNB 14 from initiating access attempts corresponding to the congested network slice.

After receiving “OVERLOAD START” message, in step S32, the gNB 14 may transmit broadcasted system information associated with changing of system information to the UE via a paging message or downlink control information (DCI). The broadcasted system information may include the local access category definition and barring control information corresponding to the local access category definition. The UE may be a concerned UE. That is, the UE may initiate an access attempt for the congested network slice. The UE AS 15 of the UE may acquire the broadcast system information sent from the gNB 14. In one embodiment, the broadcasted system information may be carried by an AS signalling such as a system information block (e.g., SIB1 or SIBx specified in NR specification). Accordingly, the disturbance on un-concerned UEs caused by system information update (e.g., paging message) can be minimized.

In step S33, the UE AS 15 may perform a system information acquisition procedure with the gNB 14 according to the broadcasted system information. In the system information acquisition procedure, the original barring control information stored in the UE may be updated based on the barring control information carried by the broadcasted system information, and the local access category definition may be provided to the UE. The UE AS 15 may obtain the local access category definition from the broadcasted system information. Since the local access category definition or the barring control information may be transmitted to the UE during the system information acquisition procedure, the core network 11 or the gNB 14 may not need to transmit additional configuration update command to the UE. Thus, signalling traffic corresponding to the UE may be decreased.

In step S34, the UE AS 15 may deliver the local access category definition to the UE NAS 13. In step S35, the UE NAS 13 may add (or store) the local access category definition. It should be noted that, the local access category definition would not change the stored local access category definition which is already stored in the UE NAS 13.

When an access attempt is initiated, the UE may determine an access category of the access attempt according to the stored access category definition or the local access category definition. Specifically, the UE NAS 13 may initiate an access attempt corresponding to a network slice. The access attempt may be generated, for example, by the application layer of the UE. The US NAS 13 may initiate the access attempt after receiving a signalling from the application layer of the UE.

The UE NAS 13 may determine the access category of the access attempt according to the stored access category definition or the local access category definition. If the local access category definition corresponding to the network slice is stored in the UE NAS 13, the UE NAS 13 may determine the access category of the access attempt according to the local access category definition. If no local access category definition is stored in the UE NAS 13, the UE NAS 13 may determine the access category of the access attempt according to the stored access category definition in the UE NAS 13. After the access category of the access attempt is determined, the UE NAS 13 may deliver the access category of the access attempt to the UE AS 15. The AS 15 may perform an access barring check for the network slice according to the access category of the access attempt. The UE AS 15 may perform the access barring check according to the barring control information, wherein the barring control information is corresponded to the access category of the access attempt.

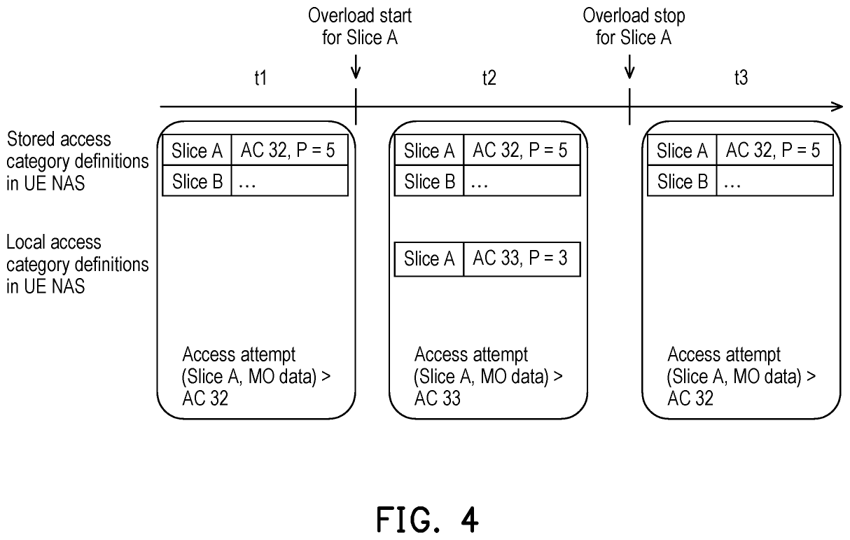

FIG. 4 illustrates a schematic diagram of determining the access category of the access attempt according to an embodiment of the disclosure. Assuming that the UE NAS 13 pre-stores the stored access category definitions associated with network slice “Slice A” and network slice “Slice B”. During time period t1, since no local access category definition corresponding to the network slice “Slice A” is stored in the UE NAS 13, if an access attempt corresponding to the network slice “Slice A” is initiated, the UE NAS 13 may determine the access category of the access attempt according to the stored access category definition. For example, the UE NAS 13 may determine the access category of the access attempt as access category “AC 32” according to the stored access category definition. Accordingly, during time period t1, the UE AS 15 may perform an access barring check for the network slice “Slice A” according to the barring control information corresponding to the access category “AC 32”, such as precedence value “P=5”.

The barring control information may include at least one mapping relationship between an access category and barring control parameters, wherein the barring control parameters may include at least one of a barring factor (e.g., uac-BarringFactor), a barring time (e.g., uac-BarringTime), or an access identity (e.g., uac-BarringForAccessIdentity). For example, the NAS signalling and the barring control information may include a mapping relationship among the network slice “Slice A”, the access category “AC 32”, and the precedence value “P=5”. Table 5 is an example of the content of the barring control information and the local access category definitions.

TABLE 5

| | | One or more S-NSSAI type definitions | | |
|---|---|---|---|---|
| | | (optional fro access category 32-63 | | |
| uac-BarringForCommon | | | one or | standardized |
| access | uac- | precedence | more S- | access |
| category | barringInfoSetIndex | value | NSSAIs | category |
| 1 | one of 1~8 | (N/A) | | |
| 2 | 3 | | | |
| . . . | . . . | | | |
| 32 | 1 | | | |
| . . . | . . . | | | |
| 63 | 1 | | | |

In one embodiment, the NAS signalling (or the access category definitions) may map the same access category to different network slices. For example, the NAS signalling may include both of a mapping relationship between the network slice “Slice A” and the access category “AC 32” and a mapping relationship between the network slice “Slice B” and the access category “AC 32”.

Assuming that a network slice congestion is occurred on the network slice “Slice A” after time period t1. The core network 11 may transmit broadcasted system information to the UE AS 15, so as to inform the UE that the network slice “Slice A” is congested. The UE AS 15 may acquire the broadcasted system information, and the UE NAS 13 may obtain the local access category definition corresponding to the network slice “Slice A” from the broadcasted system information. During time period t2, since at least one local access category definition corresponding to the network slice “Slice A” is stored in the UE NAS 13, if an access attempt corresponding to the network slice “Slice A” is initiated, the UE NAS 13 may determine the access category of the access attempt according to the local access category definition. In other words, the access category of the access attempt may be updated by the UE NAS 13 according to the local access category definition. For example, the UE NAS 13 may determine the access category of the access attempt as access category “AC 33” according to the local access category definition with precedence value “P=3”. Accordingly, the UE AS 15 may perform an access barring check for the network slice “Slice A” according to the access category “AC 33”.

Assuming that the network slice congestion occurred on the network slice “Slice A” is stop after time period t2. The core network 11 may transmit broadcasted system information to the UE AS 15, so as to inform the UE that the network slice “Slice A” is no longer congested, wherein the broadcasted system information may include no local access category definition corresponding to the network slice “Slice A”. The core network 11 may transmit the broadcasted system information via a AS signalling, such as a “OVERLOAD STOP” message. The UE AS 15 may acquire the broadcasted system information. Since no local access category definition corresponding to the network slice “Slice A” is included in the broadcasted system information, the UE NAS 13 may discard the local access category definition corresponding to the network slice “Slice A”. During time period t3, if an access attempt corresponding to the network slice “Slice A” is initiated, the UE NAS 13 may determine the access category of the access attempt according to the stored access category definition. In other words, the access category of the access attempt may be updated by the UE NAS 13 according to the stored access category definition. For example, the UE NAS 13 may determine the access category of the access attempt as access category “AC 32” according to the stored access category definition with precedence value “P=5”. Accordingly, the UE AS 15 may perform an access barring check for the network slice “Slice A” according to the access category “AC 32”.

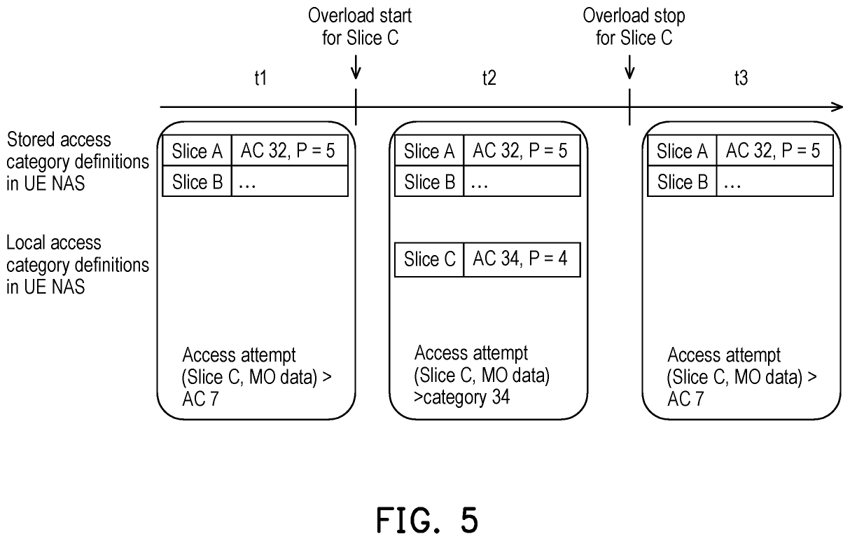

FIG. 5 illustrates a schematic diagram of determining the access category of the access attempt according to another embodiment of the disclosure. Assuming that the UE NAS 13 pre-stores the stored access category definitions associated with network slice “Slice A” and network slice “Slice B”.

During time period t1, since no local access category definition corresponding to network slice “Slice C” or stored access category definition corresponding to network slice “Slice C” is stored in the UE NAS 13, if an access attempt corresponding to the network slice “Slice C” is initiated, the UE NAS 13 may determine the access category of the access attempt according to the default access category definition. For example, the UE NAS 13 may determine the access category of the access attempt as access category “AC 7” according to the default access category definition. Accordingly, during time period t1, the UE AS 15 may perform an access barring check for the network slice “Slice C” according to the barring control information of the access category “AC 7”.

Assuming that a network slice congestion is occurred on the network slice “Slice C” after time period t1. The core network 11 may transmit broadcasted system information to the UE AS 15, so as to inform the UE that the network slice “Slice C” is congested. The UE AS 15 may acquire the broadcasted system information, and the UE NAS 13 may obtain the local access category definition corresponding to the network slice “Slice C” from the broadcasted system information. More specifically, the UE AS 15 may deliver the local access category definition to the UE NAS 13 in response to receiving the broadcasted system information. During time period t2, since at least one local access category definition corresponding to the network slice “Slice C” is stored in the UE NAS 13, if an access attempt corresponding to the network slice “Slice C” is initiated, the UE NAS 13 may determine the access category of the access attempt according to the local access category definition. In other words, the access category of the access attempt may be updated by the UE NAS 13 according to the local access category definition. For example, the UE NAS 13 may determine the access category of the access attempt as access category “AC 34” according to the local access category definition with precedence value “P=4”. Accordingly, the UE AS 15 may perform an access barring check for the network slice “Slice C” according to the access category “AC 34”.

Assuming that the network slice congestion occurred on the network slice “Slice C” is stop after time period t2. The core network 11 may transmit broadcasted system information to the UE AS 15, so as to inform the UE that the network slice “Slice C” is no longer congested, wherein the broadcasted system information may include no local access category definition corresponding to the network slice “Slice C”. The UE AS 15 may acquire the broadcasted system information. Since no local access category definition corresponding to the network slice “Slice C” or stored access category definition corresponding to the network slice “Slice C” is stored in the UE NAS 13, if an access attempt corresponding to the network slice “Slice C” is initiated during time period t3, the UE NAS 13 may determine the access category of the access attempt according to the default access category definition. In other words, the access category of the access attempt may be updated by the UE NAS 13 according to the default access category definition. For example, the UE NAS 13 may determine the access category of the access attempt as access category “AC 7” according to the default access category definition. Accordingly, during time period t3, the UE AS 15 may perform an access barring check for the network slice “Slice C” according to the barring control information of the access category “AC 7”.

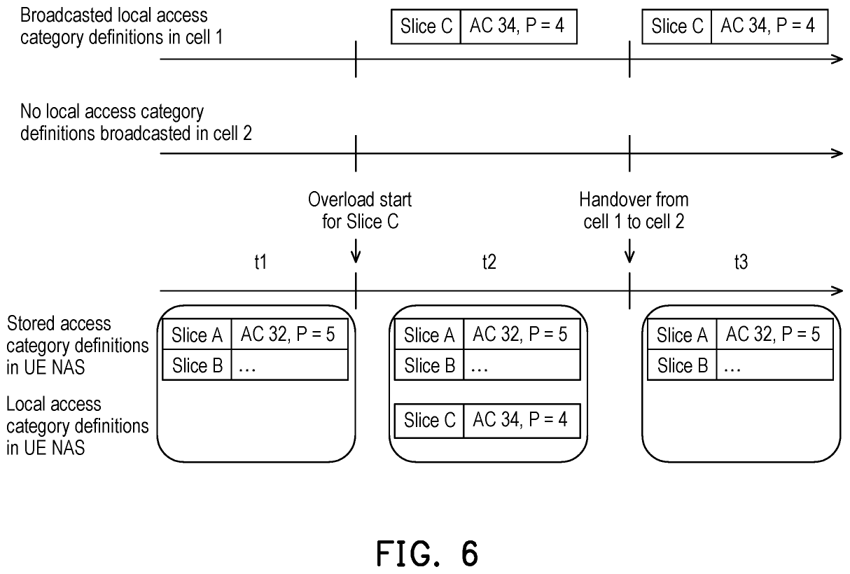

FIG. 6 illustrated a schematic diagram of determining the access category of the access attempt according to another embodiment of the disclosure. Assuming that cell 1 (or first base station) transmits broadcasted system information during time period t2 and time period t3. If the UE is served by the cell 1 during time period t2, and the UE performs a handover to cell 2 (or second base station) after time period t2. Accordingly, the UE AS 15 may acquire broadcasted system information from cell 1 during time period t2 and acquire broadcasted system information from cell 2 after performing the handover to cell 2 (e.g., during time period t3). Since cell 2 may transmit broadcasted system information involving no local access category definition during time period t3, the UE AS 15 may not receive any of the local access category definition during time period t3.

Specifically, assuming that the UE NAS 13 pre-stores the stored access category definitions associated with network slice “Slice A” and network slice “Slice B”, and assuming that that the UE is served by the cell 1 during time period t1. Since cell 1 may not transmit broadcasted system information during time period t1, the UE AS 15 may not receive broadcasted system information during time period t1. Therefore, no local access category definition would be delivered to the UE NAS 13.

If a network slice congestion is occurred on the network slice “Slice C” after time period t1, the core network 11 may transmit broadcasted system information to the UE AS 15, so as to inform the UE that the network slice “Slice C” is congested. The UE AS 15 may acquire the broadcasted system information from the cell 1, and the UE NAS 13 may obtain the local access category definition corresponding to the network slice “Slice C” from the broadcasted system information. The UE NAS 13 may store the local access category definition corresponding to the network slice “Slice C”.

If the UE performs a handover procedure to cell 2 after time period t2, the UE AS 15 may not acquire broadcasted system information from cell 1 anymore during time period t3. The UE AS 15 may acquire broadcasted system information from cell 2 during time period t3. However, since cell 2 transmits broadcasted system information involving no local access category definition during time period t3 in this embodiment, the UE AS 15 may not obtain any local access category definition during time period t3. Accordingly, no local category definition would be delivered to the UE NAS 13.

Assuming that at least one local access category definition corresponding to a network slice is stored in the UE NAS 13. If the UE AS 15 receives new broadcasted system information, the UE NAS 13 may update the local access category definition according to the new broadcasted system information. Specifically, if the new broadcasted system information includes at least one new local access category definition corresponding to the network slice, the UE NAS 13 may replace the original local access category definition stored in the UE NAS 13 by the new local access category definition. Accordingly, the UE NAS 13 may update the access category of the access attempt (i.e., access attempt corresponding to the network slice) according to the new local access category definition. In one embodiment, if no local access category definition corresponding to the network slice is included in the new broadcasted system information, the UE AS 15 may notify the UE NAS 13 no local access category definition in the new broadcasted system information. Accordingly, the UE NAS 13 may discard the local access category definition corresponding to the network slice in the UE NAS 13. Accordingly, the UE NAS 13 may update the access category of the access attempt (i.e., access attempt corresponding to the network slice) according to a stored access category definition in the UE NAS 13 or according to a default access category definition. Furthermore, the UE AS 15 may notify an upper layer (e.g., UE NAS 13) of the UE to discard the local access category definition stored in the upper layer.

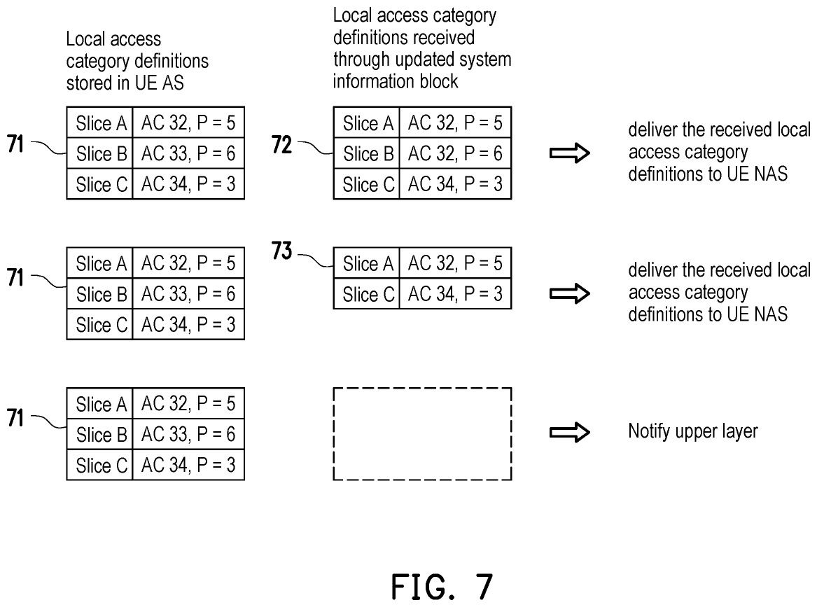

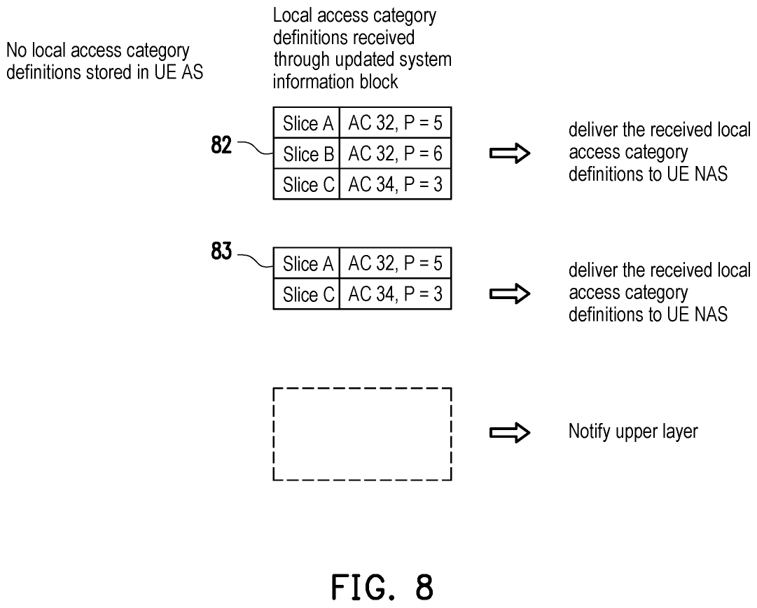

FIG. 7 illustrates a schematic diagram of UE AS 15 behavior for updating local access category definitions according to an embodiment of the disclosure. The UE NAS 13 may obtain at least one local access category definition from the UE AS 15. In one embodiment, the UE AS 15 may store the local access category definition and receive broadcasted system information from gNB 14, wherein the broadcasted system information may be carried by, for example, an updated system information block. After receiving broadcasted system information carrying at least one new local access category definition, the UE AS 15 may replace the local access category definition stored in the UE AS 15 by the new local access category definition. After that, the UE AS 15 may deliver the new local access category definition to the UE NAS 13. If no local access category definition is included in the broadcasted system information, the UE AS 15 may notify the upper layer (e.g., UE NAS 13) of the UE to discard all of the local access category definitions stored in the upper layer.

For example, the UE AS 15 may store local access category definitions 71 corresponding to network slice “Slice A”, “Slice B”, and “Slice C”. The UE AS 15 may receive an updated system information block carrying local access category definitions 72, where in the local access category definitions 72 may be corresponded to network slice “Slice A”, “Slice B”, and “Slice C”. After receiving the updated system information block, the UE AS 15 may replace the local access category definitions 71 by the local access category definitions 72, and the UE AS 15 may deliver the local access category definitions 72 to the UE NAS 13.

For another example, the UE AS 15 may store local access category definitions 71 corresponding to network slice “Slice A”, “Slice B”, and “Slice C”. The UE AS 15 may receive an updated system information block carrying local access category definitions 73, where in the local access category definitions 73 may be corresponded to network slice “Slice A” and “Slice C”. After receiving the updated system information block, the UE AS 15 may replace the local access category definitions 71 by the local access category definitions 73, and the UE AS 15 may deliver the local access category definitions 73 to the UE NAS 13.

For the other example, the UE AS 15 may store local access category definitions 71 corresponding to network slice “Slice A”, “Slice B”, and “Slice C”. The UE AS 15 may receive an updated system information block carrying no local access category definitions. After receiving the updated system information block, the UE AS 15 may discard the local access category definitions 71, and the UE AS 15 may notify an upper layer (e.g., UE NAS 13) of the UE to discard all of the local access category definitions stored in the upper layer.

FIG. 8 illustrates a schematic diagram of UE AS behavior for updating local access category definitions according to another embodiment of the disclosure. The UE NAS 13 may obtain at least one local access category definition from the UE AS 15. In one embodiment, the UE AS 15 may not store the local access category definition. The UE AS 15 may receive broadcasted system information from gNB 14, wherein the broadcasted system information may be carried by, for example, an updated system information block. After receiving broadcasted system information carrying at least one new local access category definition, the UE AS 15 may deliver the new local access category definition to the UE NAS 13 directly. If no local access category definition is included in the broadcasted system information, the UE AS 15 may notify the upper layer (e.g., UE NAS 13) of the UE to discard all of the local access category definitions stored in the upper layer.

For example, the UE AS 15 may not store any of the local access category definitions. The UE AS 15 may receive an updated system information block carrying local access category definitions 82, where in the local access category definitions 82 may be corresponded to network slice “Slice A”, “Slice B”, and “Slice C”. After receiving the updated system information block, the UE AS 15 may deliver the local access category definitions 82 to the UE NAS 13 directly.

For another example, the UE AS 15 may not store any of the local access category definitions. The UE AS 15 may receive an updated system information block carrying local access category definitions 83, where in the local access category definitions 83 may be corresponded to network slice “Slice A” and “Slice C”. After receiving the updated system information block, the UE AS 15 may deliver the local access category definitions 83 to the UE NAS 13 directly.

For the other example, the UE AS 15 may not store any of the local access category definitions. The UE AS 15 may receive an updated system information block carrying no local access category definitions. After receiving the updated system information block, the UE AS 15 may notify an upper layer (e.g., UE NAS 13) of the UE to discard all of the local access category definitions stored in the upper layer.

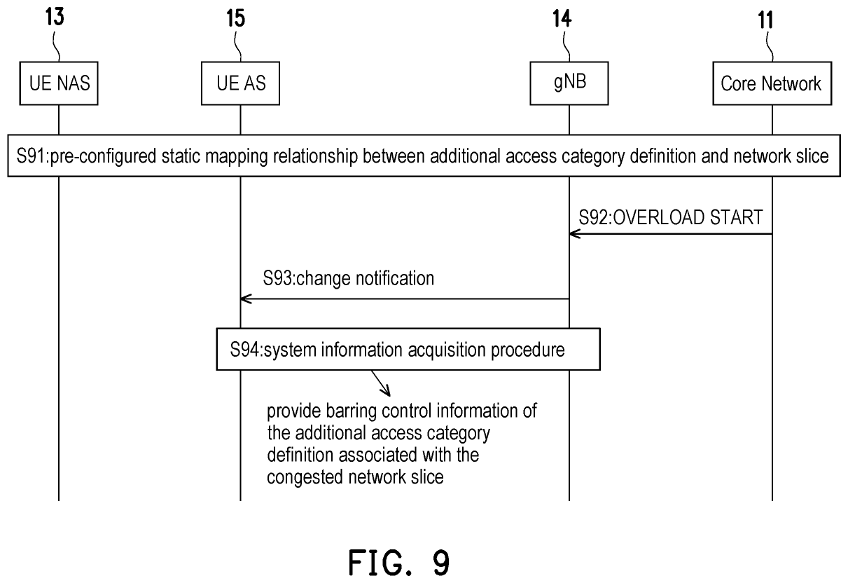

FIG. 9 illustrates a signalling diagram of obtaining barring control information associated with additional access category definitions according to an embodiment of the disclosure. In step S91, a static mapping relationship between at least one additional access category definition and at least one network slice may be pre-configured for the core network 11 and the UE NAS 13.

In one embodiment, the UE may pre-store at least one traditional access category definition corresponding to at least one network slice, and the UE may pre-store at least one additional access category definition corresponding to at least one network slice, wherein the traditional access category definition or the additional access category definition may be configured by a uncasted NAS signalling.

Specifically, the core network 11 may transmit a NAS signalling to the UE NAS 13, wherein the NAS signalling may include access category definition information to the UE NAS 13, wherein the access category definition information may include at least one additional access category definition corresponding to at least one network slice. After receiving the NAS signalling, the UE NAS 13 may acquire the access category definition information from the NAS signalling. The UE NAS 13 may obtain the additional access category definitions from the access category definition information, and store the additional access category definitions.

In one embodiment, the UE NAS 14 may obtain and store at least one traditional access category definition corresponding to at least one network slice before step S91 or in step S91. For example, the access category definition information may further include at least one traditional access category definition corresponding to the at least one network slice. The traditional access category definition may be an access category definition defined by 3GPP specification TS 24.501. The additional access category definition may be an access category definition not defined by 3GPP specification TS 24.501. The traditional access category definition or the additional access category definition may be one of operator-defined access category definitions.

In step S92, when a network slice congestion occurs, the core network 11 may transmit a message, such as “OVERLOAD START” message, to the gNB 14 so as to indicate the congested network slice, wherein the message may include data related to barring control information of the additional access category definition corresponding to the congest network slice. The gNB 14 may include several concerned cells to the core network 11. That is, the core network 11 wants to prevent the concerned cells belonged to gNB 14 from initiating access attempts corresponding to the congested network slice.

The barring control information may include at least one mapping relationship between an access category and barring control parameters, wherein the barring control parameters may include at least one of a barring factor (e.g., uac-BarringFactor), a barring time (e.g., uac-BarringTime), or an access identity (e.g., uac-BarringForAccessIdentity). In one embodiment, the NAS signalling and the barring control information may map the same access category to different network slices. For example, the barring control information may include both of a mapping relationship between the network slice “Slice A” and the access category “AC 32” and a mapping relationship between the network slice “Slice B” and the access category “AC 32”. Table 6 is an example of the content of the barring control information of the additional access category definitions.

TABLE 6

| | | uac-BarringInfoSetList | | |
|---|---|---|---|---|
| uac-BarringForCommon | | uac- | uac- | |
| accessCategory | uac-barring | Barring | Barring | uac-Barring |
| Add | InfoSetindex | Factor | Time | ForAccessIdentity |
| 1 | one of 1~8 | . . . | . . . | . . . |
| 5 | 3 | . . . | . . . | . . . |
| . . . | . . . | . . . | . . . | . . . |
| 1000 | 1 | p00, p05, | s4, s8, | BIT STRING |
| | | . . . , p95 | . . . , s512 | (SIZE(7)) |

After receiving “OVERLOAD START”, in step S93, the gNB 14 may transmit a broadcasted system information associated with changing of system information (i.e., a change notification) to the UE via a paging message or DCI. The broadcasted system information may include the barring control information of the additional access category definition corresponding to the congested network slice. The UE may be a concerned UE. That is, the UE may initiate an access attempt for the congested network slice. The UE AS 15 may acquire the broadcast system information sent from the gNB 14. In one embodiment, the broadcasted system information may be carried by an AS signalling such as a system information block (e.g., SIB1 or SIBx specified in NR specification). Table 7 is an example of SIB1 defined by 3GPP specification TS 38.331.

```
TABLE 7
SIB1: UAC-Barring Information enhancement
UAC-BarringPerCatList information element
    -- ASN1 START
    -- TAG-UAC-BARRINGPERCATLIST-START
UAC-BarringPerCatList ::= SEQUENCE (SIZE (1..maxAccessCat-1))
OF UAC-BarringPerCat
UAC-BarringPerCat ::= SEQUENCE {
  accessCategory INTEGER (1...maxAccessCat-1),
  uac-barringInfoSetIndex UAC-BarringInfoSetIndex
}
UAC-BarringPerCatListAdd ::= SEQUENCE (SIZE
(1..addAccessCat-1)) OF UAC-BarringPerCatadd
UAC-BarringPerCatAdd ::= SEQUENCE {
    accessCategoryAdd INTEGER(1..addAccessCat-1)
    uac-barringInfoSetIndex UAC-BarringInfoSetIndex
}
-- TAG-UAC-BARRINGPERCATLIST-STOP
-- ASN1STOP
```

In step S94, the UE AS 15 may perform a system information acquisition procedure with the gNB 14 according to the broadcasted system information. In the system information acquisition procedure, the barring control information of the additional access category definition may be provided to the UE AS 15. When an access attempt is initiated, the UE may determine an access category of the access attempt according to the stored access category definition or the additional access category definition. Specifically, the UE NAS 13 may initiate an access attempt corresponding to a network slice. The US NAS 13 may initiate the access attempt after receiving a signalling from the application layer of the UE.

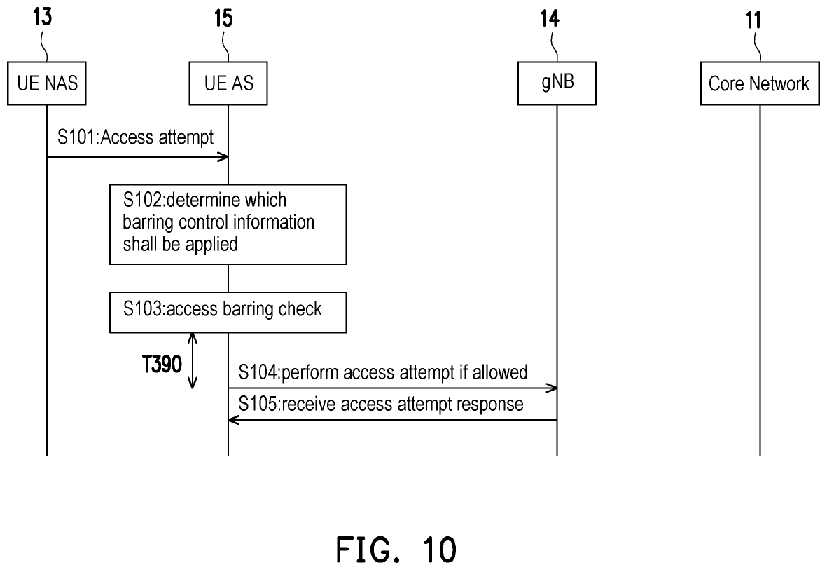

FIG. 10 illustrates a signalling diagram of a procedure of slice-based access barring according to an embodiment of the disclosure. Assuming an access attempt corresponding to the congested network slice is initiated. After the UE NAS 13 initiates the access attempt, in step S101, the UE NAS 13 may deliver the access attempt to the UE AS 15. In one embodiment, the UE NAS 13 may deliver the traditional access category (i.e., access category defined by the traditional access category definition) or the additional access category (i.e., access category defined by the additional access category definition) to the UE AS 15 along with the access attempt, wherein the traditional access category or the additional access category are associated with the network slice.

In step S102, the UE AS 15 may determine which barring control which barring control information shall be applied. In one embodiment, if the barring control information of the additional access category definition has been received by the UE AS 15 (e.g., in step S94), the UE AS 15 may determine to perform the access barring check for the access attempt according to the barring control information of the additional access category. If the barring control information of the additional access category definition has not been received by the UE AS 15, the UE AS 15 may determine to perform the access barring check for the access attempt according to the barring control information of the traditional access category.

Assuming the barring control information has been obtained by the UE AS 15, and assuming that the UE stores a traditional access category definition corresponding to a congested network slice and stores an additional access category definition corresponding to the congested network slice. In one embodiment, if the traditional access category definition corresponding to the congest network slice is not matched with a default access category definition, the UE AS 15 may determine which barring control information shall be applied. If the traditional access category definition corresponding to the congest network slice is matched with the default access category definition, the UE AS 15 may determine to perform the access barring check for the access attempt according to the barring control information of the traditional access category. The default access category definition may correspond to an access category for emergency, such as “access category 0” or “access category 2” defined in the 3GPP specification TS 24.501.

After the barring control information applied to the access attempt is determined, in step S103, the UE AS 15 may perform an access barring check for the network slice according to the access category. If the barring control information applied to the access attempt is determined based on the traditional access category, the UE AS 15 may perform the access barring check according to the barring control information of the traditional access category. If the barring control information applied to the access attempt is determined based on the additional access category definition, the UE AS 15 may perform the access barring check according to the barring control information of the additional access category. For example, the barring control information may include barring time. The UE AS 15 may perform the access barring check according to timer T390 corresponding to the barring time.

If the result of the access barring check shows that the access attempt to the network slice is allowed, in step S104, the UE AS 15 may perform the access attempt by accessing the gNB 14. In step S105, after being accessed by the UE, the gNB 14 may send an access attempt response corresponding to the access attempt to the UE AS 15.

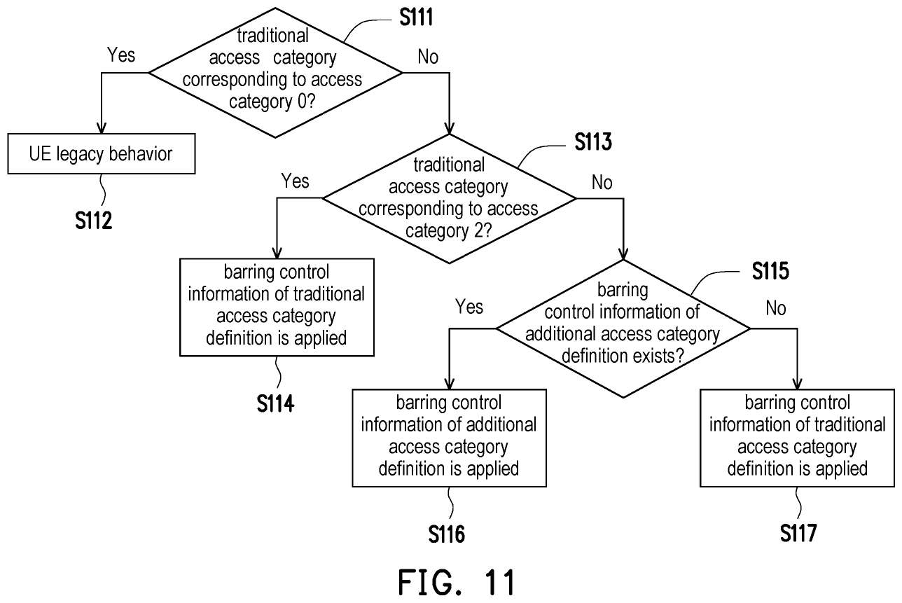

FIG. 11 illustrates a flowchart diagram of a method for determining which barring control information shall be applied according to an embodiment of the disclosure, wherein the method may be implemented by a UE. Assuming that the UE stores at least one traditional access category definition corresponding to a network slice and stores at least one additional access category definition corresponding to the network slice.

If an access attempt corresponding to the network slice is initiated, in step S111, the UE may check if the access attempt is mapped to a traditional access category corresponded to “access category 0”, wherein “access category 0” is associated with a default access category definition. If the traditional access category is corresponded to “access category 0”, proceed to step S112. If the traditional access category definition is not corresponded to “access category 0”, proceed to step S113.

In step S112, the UE may perform legacy behavior corresponding to “access category 0”. “access category 0” represents that the access attempt for the network slice is always passed.

In step S113, the UE may check if the access attempt is mapped to a traditional access category corresponded to “access category 2”, wherein “access category 2” is associated with a default access category definition. If the traditional access category is corresponded to “access category 2”, proceed to step S114. If the traditional access category is not corresponded to “access category 2”, proceed to step S115. It should be noted that the priority of “access category 0” is higher than the priority of “access category 2”, so the UE first checks if the access attempt belongs to “access category 0”, then the UE checks if the access attempt belongs to “access category 2”.

In step S114, the barring control information of the traditional access category corresponding to “access category 2” is applied by the UE. The UE may perform an access barring check based on the barring control information of “access category 2”.

In step S115, the UE may determine whether the barring control information of the additional access category exists (i.e., stored by the UE). If the barring control information of the additional access category does exist, proceed to step S116. If the barring control information of the additional access category does not exist, proceed to step S117.

In step S116, the barring control information of the additional access category definition is applied by the UE. The UE may perform an access barring check based on the barring control information of the additional access category.

In step S117, the barring control information of the traditional access category is applied by the UE. The UE may perform an access barring check based on the barring control information of the traditional access category (e.g., barring control information corresponding to a default access category definition).

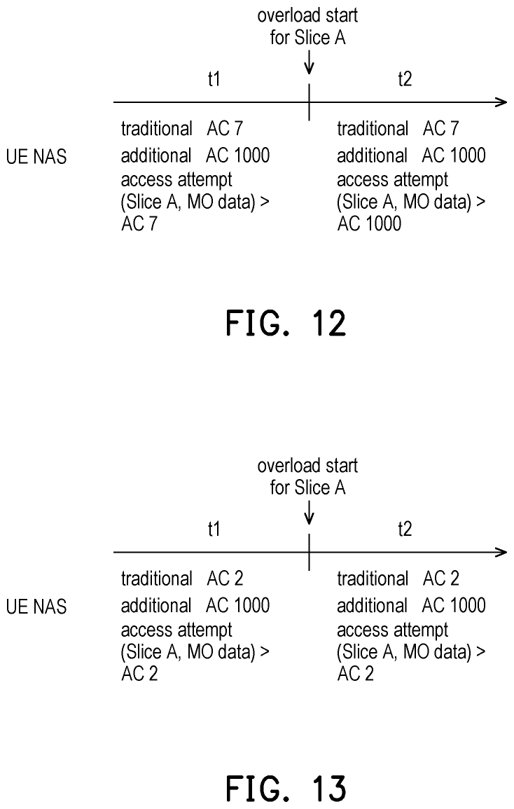

FIG. 12 illustrates a schematic diagram of access category of an access attempt according to an embodiment of the disclosure. The US NAS 13 may store a traditional access category definition of access category “AC 7” and may store an additional access category definition of access category “AC 1000”. The US NAS 13 may deliver a traditional access category “AC 7” to the UE AS 15 and may deliver an additional access category “AC 1000” to the UE AS 15. The US AS 15 may store the traditional access category “AC 7” and may store the additional access category “AC 1000”, wherein access category “AC 7” and access category “AC 1000” are associated with the access attempt corresponding to network slice “Slice A”. Assuming that the barring control information of access category “AC 1000” is not received by the UE before the end of time period t1. That is, the barring control information of the additional access category does not exist during time period t1. Assuming that an access attempt corresponding to the network slice “Slice A” is initiated during time period t1, since the barring control information of the additional access category definition does not exist, the UE AS 15 may apply the barring control information of access category “AC 7” to the access attempt.

If a network slice congestion occurred on the network slice “Slice A” after time period t1, the gNB 14 may transmit barring control information of access category “AC 1000” to the UE via broadcasted system information, wherein the broadcasted system information may be carried by an AS signalling. During time period t2, if the barring control information of the additional access category does exist, the UE AS 15 may apply the barring control information of the additional access category to the access attempt. Accordingly, the UE AS 15 may apply the barring control information of access category “AC 1000” to the access attempt.

FIG. 13 illustrates a schematic diagram of access category of an access attempt according to another embodiment of the disclosure. The US NAS 13 may store a traditional access category definition of access category “AC 2” and may store an additional access category definition of access category “AC 1000”. The US NAS 13 may deliver a traditional access category “AC 2” to the UE AS 15 and may deliver an additional access category “AC 1000” to the UE AS 15. The US AS 15 may store the traditional access category “AC 2” and may store the additional access category “AC 1000”, wherein access category “AC 2” and access category “AC 1000” are associated with the access attempt corresponding to network slice “Slice A”, and the access category “AC 2” is associated with a default access category definition for emergency. Assuming that the barring control information of access category “AC 1000” is not received by the UE before the end of time period t1. That is, the barring control information of the additional access category does not exist during time period t 1. Assuming that an access attempt corresponding to the network slice “Slice A” is initiated during time period t1, since the barring control information of the additional access category does not exist, the UE AS 15 may apply the barring control information of access category “AC 2” to the access attempt.

If a network slice congestion occurred on the network slice “Slice A” after time period t1, the gNB 14 may transmit barring control information of access category “AC 1000” to the UE via broadcasted system information, wherein the broadcasted system information may be carried by an AS signalling. During time period t2, in response to the access category “AC 2” being matched with the default access category definition, even if the barring control information of the additional access category definition does exist, the UE AS 15 may apply the barring control information of access category “AC 2” to the access attempt.

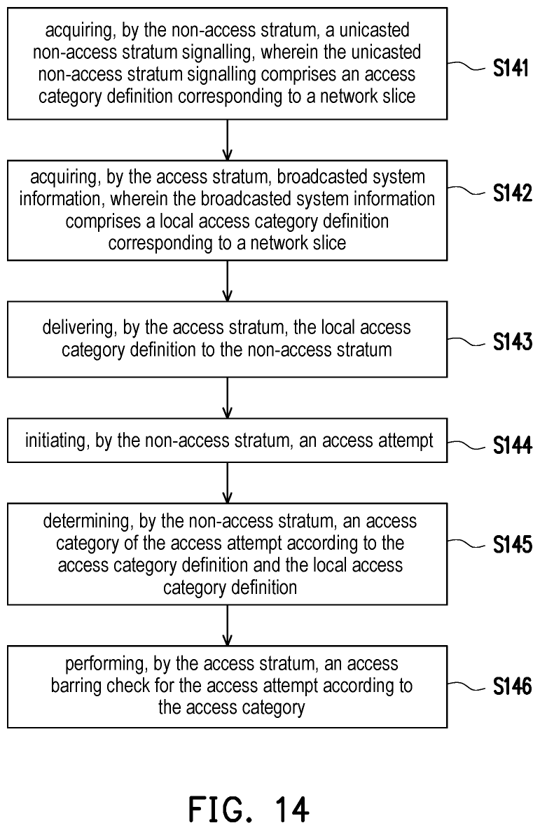

FIG. 14 illustrates a flowchart diagram of a method for slice-based access barring according to an embodiment of the disclosure, wherein the method is adapted to a UE comprising an access stratum and a non-access stratum. In step S141, acquiring, by the non-access stratum, a unicasted non-access stratum signalling, wherein the unicasted non-access stratum signalling comprises an access category definition corresponding to a network slice. In step S142, acquiring, by the access stratum, broadcasted system information, wherein the broadcasted system information comprises a local access category definition corresponding to a network slice. In step S143, delivering, by the access stratum, the local access category definition to the non-access stratum. In step S144, initiating, by the non-access stratum, an access attempt. In step S145, determining, by the non-access stratum, an access category of the access attempt according to the access category definition and the local access category definition. In step S146, performing, by the access stratum, an access barring check for the access attempt according to the access category.

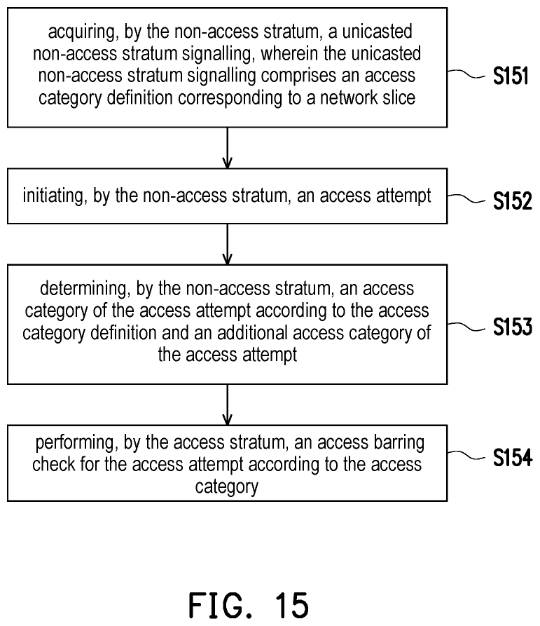

FIG. 15 illustrates a flowchart diagram of a method for slice-based access barring according to another embodiment of the disclosure, wherein the method is adapted to a UE comprising an access stratum and a non-access stratum. In step S151, acquiring, by the non-access stratum, a unicasted non-access stratum signalling, wherein the unicasted non-access stratum signalling comprises an access category definition corresponding to a network slice. In step S152, initiating, by the non-access stratum, an access attempt. In step S153, determining, by the non-access stratum, an access category of the access attempt according to the access category definition and an additional access category of the access attempt. In step S154, performing, by the access stratum, an access barring check for the access attempt according to the access category.

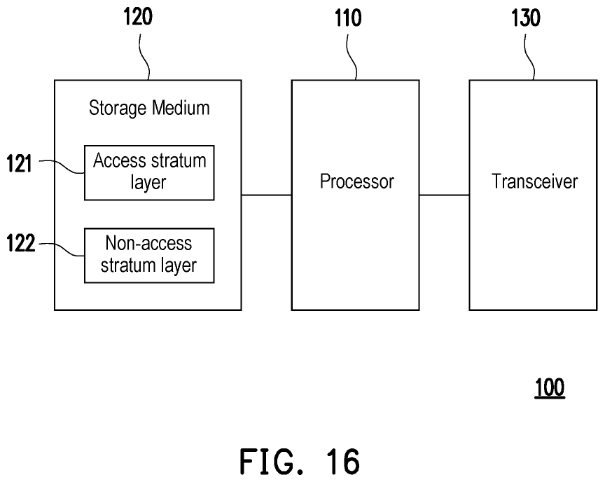

FIG. 16 illustrates a schematic diagram of a UE 100 according to an embodiment of the disclosure. The UE 100 may include a processor 110, a storage medium 120, and a transceiver 130. The processor 110 is coupled to the storage medium 120 and the transceiver 130 and is configured to at least to implement the method as described in FIG. 1-16 as well as its exemplary embodiment and alternative variations.

The processor 110 could be implemented by using programmable units such as a micro-processor, a micro-controller, a DSP chips, FPGA, etc. The functions of the processor 110 may also be implemented with separate electronic devices or ICs. It should be noted that the functions of processor 110 may be implemented with either hardware or software.

The storage medium 120 may be, for example, any type of fixed or removable random access memory (RAM), a read-only memory (ROM), a flash memory, a hard disk drive (HDD), a solid state drive (SSD) or similar element, or a combination thereof, configured to record a plurality of modules or various applications executable by the processor 110. In one embodiment, the storage medium 120 may store an access stratum 121 and a non-access stratum 122, wherein the UE AS 15 and the UE NAS 13 mentioned above may be implemented by the access stratum 121 and the non-access stratum 122 respectively.

The transceiver 130 may be configured to transmit and receive signals respectively in the radio frequency or in the mmWave frequency. The transceiver 130 may also perform operations such as low noise amplifying, impedance matching, frequency mixing, up or down frequency conversion, filtering, amplifying, and so forth. The transceiver 130 may include one or more digital-to-analog (D/A) converters or analog-to-digital (A/D) converters which are configured to convert from an analog signal format to a digital signal format during uplink signal processing and from a digital signal format to an analog signal format during downlink signal processing. The transceiver 130 may include an antenna array which may include one or multiple antennas to transmit and receive omni-directional antenna beams or directional antenna beams.

Based on the above, the disclosure may provide a stored access category definition to the UE such that the UE may pre-store the stored access category definition, and the disclosure may provide a local access category definition to the UE dynamically. When a network slice congestion occurs, the UE may determine an access category of an access attempt according to the local access category definition rather than the stored access category definition only if broadcasted system information corresponding to the local access category definition was received by the UE. Otherwise, the UE may determine the access category of the access attempt according to the stored access category definition, and the network may not have to send any signalling to the UE. On the other hand, the disclosure may provide an additional access category definition to the UE. When a network slice congestion occurs, the UE may determine an access category of an access attempt according to the additional access category definition rather than a traditional access category definition only if barring control information corresponding to the additional access category definition was received by the UE. Otherwise, the UE may determine the access category of the access attempt according to the traditional access category definition. Accordingly, the network may command the UE to stop accessing a congested network slice in any time even if the number of the signalling between the network and the UE is minimized.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A method for slice-based access barring, adapted to a user equipment comprising an access stratum and a non-access stratum, wherein the method comprising:
acquiring, by the non-access stratum, a unicasted non-access stratum signalling, wherein the unicasted non-access stratum signalling comprises an access category definition corresponding to a network slice;
acquiring, by the access stratum, broadcasted system information, wherein the broadcasted system information comprises a local access category definition corresponding to the network slice;
delivering, by the access stratum, the local access category definition to the non-access stratum;
initiating, by the non-access stratum, an access attempt;
determining, by the non-access stratum, an access category of the access attempt according to the access category definition and the local access category definition; and
performing, by the access stratum, an access barring check for the access attempt according to the access category.

2. The method according to claim 1, further comprising:
acquiring, by the access stratum, second broadcasted system information after acquiring the broadcasted system information, wherein the second broadcasted system information comprises a second local access category definition;
delivering, by the access stratum, the second local access category definition to the non-access stratum; and
updating, by the non-access stratum, the local access category definition to the second local access category definition.

3. The method according to claim 1, further comprising:
acquiring, by the access stratum, second broadcasted system information after acquiring the broadcasted system information, wherein the second broadcasted system information comprises no local access category definition;
notifying, by the access stratum, no local access category definition in the second broadcasted system information to the non-access stratum; and
discarding, by the non-access stratum, the local access category definition in response to no local access category definition in the second broadcasted system information.

4. The method according to claim 2, wherein the access stratum acquires the broadcasted system information from a first base station, and the access stratum acquires the second broadcasted system information from a second base station after performing a handover from the first base station to the second base station.

5. The method according to claim 1, wherein the broadcasted system information further comprises barring control information corresponding to the local access category definition, wherein the access stratum performs the access barring check according to the barring control information.

6. The method according to claim 1, wherein the local access category definition is associated with an operator-defined access category.

7. A method for slice-based access barring, adapted to a user equipment comprising an access stratum and a non-access stratum, wherein the method comprising:
acquiring, by the non-access stratum, a unicasted non-access stratum signalling, wherein the unicasted non-access stratum signalling comprises an access category definition corresponding to a network slice;
initiating, by the non-access stratum, an access attempt;
determining, by the non-access stratum, an access category of the access attempt according to the access category definition and an additional access category of the access attempt; and
performing, by the access stratum, an access barring check for the access attempt according to the access category.

8. The method according to claim 7, further comprising:
acquiring, by the access stratum, broadcasted system information, wherein the broadcasted system information comprises a barring control information corresponding to a second additional access category;
performing the access barring check according to the barring control information if the additional access category of the access attempt is equal to the second additional access category; and
performing the access barring check according to a second barring control information corresponding to the access category of the access attempt if the additional access category of the access attempt is not equal to the second additional access category.

9. The method according to claim 7, wherein the unicasted non-access stratum signalling comprises a mapping relationship between the additional access category and the network slice.

10. A user equipment (UE) for slice-based access barring, comprising:
a transceiver;
a storage medium, comprising an access stratum and a non-access stratum; and
a processor coupled to the storage medium and the transceiver, wherein the processor is configured to:
acquire, by the non-access stratum, a unicasted non-access stratum signalling via the transceiver, wherein the unicasted non-access stratum signalling comprises an access category definition corresponding to a network slice;
acquire, by the access stratum, broadcasted system information via the transceiver, wherein the broadcasted system information comprises a local access category definition corresponding to the network slice;
deliver, by the access stratum, the local access category definition to the non-access stratum;
initiate, by the non-access stratum, an access attempt;
determine, by the non-access stratum, an access category of the access attempt according to the access category definition and the local access category definition; and
perform, by the access stratum, an access barring check for the access attempt according to the access category via the transceiver.

11. A user equipment (UE) for slice-based access barring, comprising:
a transceiver;
a storage medium, comprising an access stratum and a non-access stratum; and
a processor coupled to the storage medium and the transceiver, wherein the processor is configured to:
acquire, by the non-access stratum, a unicasted non-access stratum signalling via the transceiver, wherein the unicasted non-access stratum signalling comprises an access category definition corresponding to a network slice;
initiate, by the non-access stratum, an access attempt;
determine, by the non-access stratum, an access category of the access attempt according to the access category definition and an additional access category of the access attempt; and
perform, by the access stratum, an access barring check for the access attempt according to the access category.
